(19) United States
(12) Patent Application Publication
(10) Pub. No.: US 2005/0255781 A1
(43) Pub. Date: Nov. 17, 2005

(54) Aging method for plasma display panel

(76) Inventor: Sung Chun Choi, Anyang-si (KR)

Correspondence Address: MCKENNA LONG & ALDRIDGE LLP, 1900 K STREET, NW, WASHINGTON, DC, 20006, US

(21) Appl. No.: 11/129,296

(22) Filed: May 16, 2005

(30) Foreign Application Priority Data
May 14, 2004 (KR) 10-2004-0034470

(51) Int. Cl. H01J 9/44; H01J 9/00; H01J 17/49

(52) U.S. Cl. 445/6; 445/5

(57) ABSTRACT

The present invention relates to an aging method for a plasma display panel. In the aging method, a sustain discharge pulse having a lower discharge voltage than a reference voltage is alternatingly applied to a scan electrode and a sustain electrode of a front panel, and the same voltage as or a higher voltage than the reference voltage is applied to an address electrode of a rear panel, thereby generating discharge.

This Nonprovisional application claims priority under 35 U.S.C. § 119(a) on Patent Application No. 10-2004-0034470 filed in Korea on May 14, 2004, the entire contents of which are hereby incorporated by reference.

### BACKGROUND OF THE INVENTION

1. Field of the Invention

The present invention relates to an aging method for a plasma display panel, and more particularly, to an aging method for a plasma display panel, for minimizing dielectric breakdown of a panel, and preventing variation of an aging characteristic.

2. Description of the Background Art

In general, plasma display panel (Hereinafter, referred to as “PDP”) includes a front substrate and a rear substrate formed of soda-lime glass, and a barrier rib defining one unit cell between the front substrate and the rear substrate. Main discharge gas such as neon (Ne), helium (He) or a combination of neon and helium (Ne+He) and inert gas containing a small amount of xenon (Xe) are filled into each cell. When the inert gas is discharged due to a high frequency voltage, the inert gas generates vacuum ultraviolet ray and excites phosphor between the barrier ribs, thereby displaying an image.

FIG. 1 is a perspective view illustrating a schematic structure of a conventional plasma display panel.

As shown in FIG. 1, the PDP 100 includes a front panel 10 forming a display surface for displaying an image; and a rear panel 20 forming a rear surface. The front panel 10 and the rear panel 20 are spaced apart and combined in parallel with each other.

The front panel 10 includes a pair of a scan electrode 11Y and a sustain electrode 1Z for mutually discharging in one pixel and sustaining cell emission, that is, a scan electrode 11Y and a sustain electrode 11Z each having a transparent electrode 11a formed of Indium-Tin-Oxide (ITO) and a bus electrode 11b formed of metal. The scan electrode 11Y and the sustain electrode 11Z are covered with at least one dielectric layer 12 for preventing discharge current and insulating between the paired electrodes. A protective layer 13 is formed of magnesium oxide (MgO) on the dielectric layer 12 to facilitate a discharge condition.

In the rear panel 20, a stripe type (or well type) barrier rib 21 is arranged keeping in parallel to form a plurality of discharge spaces, that is, discharge cells. A plurality of address electrodes 22 are arranged to be in parallel with the barrier rib 21 to perform an address discharge, thereby generating vacuum ultraviolet ray. Red (R), Green (G) and Blue (B) phosphors 23 are coated on the rear panel 23 to emit visible ray in the address discharge, thereby displaying an image. A white-color dielectric 24 is formed between the address electrode 22 and the phosphors 23 to protect the address electrode 22 and reflect the emitted visible ray of the phosphor 23 toward the front panel 10.

A black matrix 21a is arranged on the barrier rib 21 to serve a function of light blockage for absorbing external light from the front panel 10, thereby reducing reflection of light, and a function of improving the purity and the contrast of the front panel 10. A manufacture method of the above PDP will be in detail described with reference to FIG. 2.

FIG. 2 is a block diagram illustrating a manufacture method of a conventional plasma display panel.

As shown in FIG. 2, the PDP is completely manufactured through a front panel manufacturing step (S201), a rear panel manufacturing step (S202), front panel and rear panel attaching step (S203), an exhaust and gas injection step (S204), and a panel aging step (S205).

In the front panel manufacturing step (S201), a plurality of pairs of scan electrodes and sustain electrodes are formed on a front glass, and the dielectric layer is formed on the paired electrodes. After that, the protective layer of magnesium oxide (MgO) is formed on the dielectric layer to manufacture the front panel of the PDP.

In the rear panel manufacturing step (S202), the address electrode is formed on a rear glass to intersect with and face the pair of the scan electrode and the sustain electrode. After that, the dielectric layer, the barrier rib and the phosphor layer are formed on the address electrode, to manufacture the rear panel of the PDP.

Next, the front panel and the rear panel of the PDP are attached with each other (S203).

In the exhaust and gas injection step (S204), air is exhausted through an exhaust pipe and the inert gas is injected between the front panel and the rear panel. Next, the exhaust pipe is tipped-off to finish the panel manufacturing steps of the PDP.

When the same voltage is applied to the manufactured panel, the manufactured panel has a different characteristic of discharge due to its nonuniform characteristic of each region. At this time, if the sustain discharge pulse is applied to the panel with its gradually increasing voltage to initially discharge all cells of the panel, and the sustain discharge pulse is continuously applied for a predetermined time to sustain an initial discharge, the panel has an effect of considerable stabilized characteristic. It is the panel aging step to use this effect (S205).

FIG. 3 is a waveform diagram illustrating the sustain discharge pulse applied in the conventional aging step.

As shown in FIG. 3, the alternating sustain discharge pulse is applied to the scan electrode and the sustain electrode. The alternating sustain discharge pulse allows a surface discharge to be repetitively generated between the scan electrode and the sustain electrode. At this time, a voltage applied to the address electrode is 0V.

A method of generating an initial discharge using the surface discharge between the scan electrode and the sustain electrode requires much high voltage. This method has a drawback in that an inter-electrode dielectric breakdown is generated in the panel having less process margin, thereby decreasing a yield of product because the dielectric breakdown panel is a bad panel, not any longer good panel.

The conventional aging method has a drawback in that because the address electrode is charged with a lower voltage than the scan electrode and the sustain electrode, an electric potential of the address electrode becomes different due to positive ions stored on the address electrode, thereby changing an aging characteristic.

### SUMMARY OF THE INVENTION

Accordingly, an object of the present invention is to solve at least the problems and disadvantages of the background art.

An object of the present invention is to provide an aging method for a plasma display panel, for minimizing dielectric breakdown of a panel and preventing variation of an aging characteristic.

To achieve these and other advantages and in accordance with the purpose of the present invention, as embodied and broadly described, there is provided an aging method for a plasma display panel, wherein a sustain discharge pulse having a lower discharge voltage than a reference voltage is alternatingly applied to a scan electrode and a sustain electrode of a front panel, and the same voltage as or a higher voltage than the reference voltage is applied to an address electrode of a rear panel, thereby generating discharge.

The inventive aging method can generate an initial discharge with a lower voltage using an opposite discharge, which is caused by a voltage difference between the electrode for applying the discharge voltage and the address electrode, and allow the address electrode to have a higher voltage than the scan electrode and the sustain electrode, thereby reducing storage of charges and preventing the variation of the aging characteristic.

### BRIEF DESCRIPTION OF THE DRAWINGS

The invention will be described in detail with reference to the following drawings in which like numerals refer to like elements.

FIG. 1 is a perspective view illustrating a schematic structure of a conventional plasma display panel;

FIG. 2 is a block diagram illustrating a manufacture method of a conventional plasma display panel;

FIG. 3 is a waveform diagram illustrating a sustain discharge pulse applied in a conventional aging method;

FIG. 4 is a waveform diagram illustrating a sustain discharge pulse applied in an aging method according to an embodiment of present invention; and

FIG. 5 is a waveform diagram illustrating a sustain discharge pulse applied in an aging method according to another embodiment of the present invention.

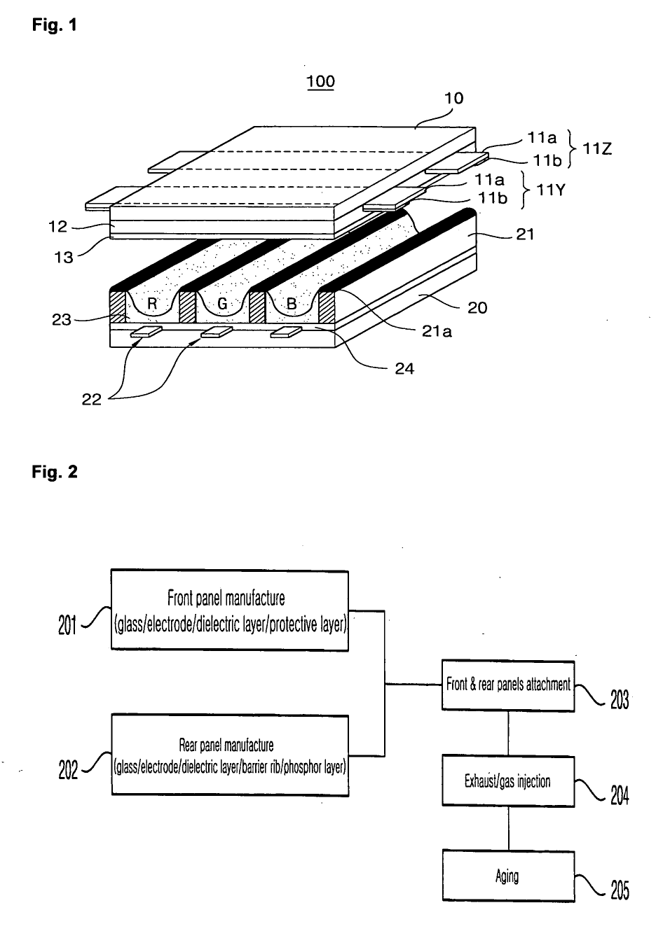

### DETAILED DESCRIPTION OF PREFERRED EMBODIMENTS

Preferred embodiments of the present invention will be described in a more detailed manner with reference to the drawings.

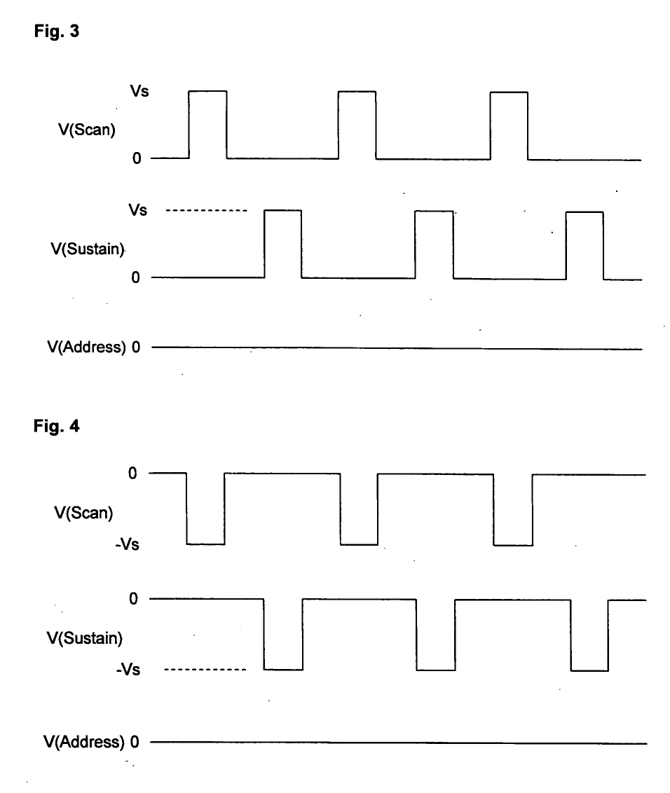

FIG. 4 is a waveform diagram illustrating a sustain discharge pulse applied in an aging method according to an embodiment of present invention.

As shown in FIG. 4, the alternating sustain discharge pulse is applied to a scan electrode and a sustain electrode. The sustain discharge pulse has a reference voltage of 0V, and has a discharge voltage of −Vs lower than the reference voltage. The same voltage as the reference voltage (0V) is continuously applied to the address electrode.

As the voltages are applied, positive ions move to a magnesium oxide (MgO) layer of a front panel due to the scan electrode and the sustain electrode having a lower voltage than the address electrode. Since the MgO layer of the front panel has a larger secondary electron emission coefficient than a phosphor layer of a rear panel, the front panel emits more secondary electrons than the rear panel. Accordingly, an initial opposite discharge is generated between the scan or sustain electrode and the address electrode. It can be appreciated that the initial opposite discharge is easily generated at a lower voltage than a conventional surface discharge generated between the scan electrode and the sustain electrode.

After the initial opposite discharge is generated, the initial opposite discharge is sustained depending on the sustain discharge pulse applied for a predetermined time, as follows.

First, an opposite discharge is generated between the scan or sustain electrode and the address electrode depending on the applied pulse.

Next, a surface discharge is generated by charging from the opposite discharge generating electrode to the opposite discharge non-generating electrode.

After that, an opposite discharge is generated between the opposite discharge non-generating electrode and the address electrode.

The above processes are repeatedly performed for a predetermined time to stabilize a panel characteristic of a plasma display panel (PDP).

The discharge voltage of the sustain discharge pulse should have a duty ratio of 50% or less in consideration of a characteristic of the alternating sustain discharge pulse.

In the embodiment of FIG. 4, the same voltage as the reference voltage (0V) is applied to the address electrode, but in a modified example, a higher voltage than the reference voltage (0V) can be also applied to the address electrode to increase a difference with the discharge voltage.

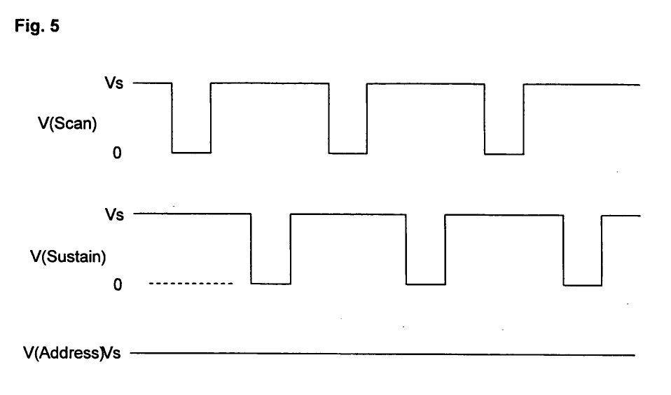

The reference voltage can be also applied more than 0V. Its detailed description will be made with reference to FIG. 5.

FIG. 5 is a waveform diagram illustrating a sustain discharge pulse applied in an aging method according to another embodiment of the present invention.

As shown in FIG. 5, an alternating sustain discharge pulse is applied to the scan electrode and a sustain electrode. The sustain discharge pulse has a reference voltage of Vs, and has a discharge voltage of 0V lower than the reference voltage. The same voltage as the reference voltage (Vs) is continuously applied to the address electrode.

Since the initial discharge is caused by a difference between the discharge voltage and the address electrode voltage, the reference voltage can be larger than 0V. At this time, the discharge voltage lower than the reference voltage is applied.

The discharge voltage of the sustain discharge pulse should have a duty ratio of 50% or less in consideration of a characteristic of the alternating sustain discharge pulse.

In FIG. 5, the same voltage as the reference voltage (Vs) is applied to the address electrode, but in a modified example, a higher voltage than the reference voltage (Vs) can be also applied to the address electrode to increase a difference with the discharge voltage.

The inventive aging method can prevent positive ions from being stored on the address electrode in a conventional aging method performed after the initial discharge. That is, the address electrode is charged with a relatively high voltage and accordingly, negative electrons are stored on the address electrode. The electrons advantageously decrease storage of charges in the aging step due to their smaller quantity of stored charges of each region than ions. Accordingly, the inventive aging method can prevent the aging characteristic from being varied depending on the storage of charges.

As described above, the present invention has an effect of minimizing dielectric breakdown of the panel, and preventing variation of the aging characteristic.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An aging method of a plasma display panel including a san electrode and a sustain electrode in a front panel and an address electrode in a rear panel,
wherein a sustain discharge pulse having a lower discharge voltage than a reference voltage is alternatively applied to the scan electrode and the sustain electrode of the front panel, and the same as the reference voltage or a higher voltage than the reference voltage is applied to the address electrode of the rear panel, whereby generating discharge.

2. The method of claim 1, wherein the discharge is performed by comprising the steps of:
generating an opposite discharge between the scan or sustain electrode and the address electrode depending on the applied sustain discharge pulse;
generating a surface discharge by charging from the opposite discharge generating electrode to the opposite discharge non-generating electrode; and
generating an opposite discharge between the opposite discharge non-generating electrode and the address electrode.

3. The method of claim 1, wherein the address electrode voltage is continuously applied.

4. The method of claim 1, wherein the discharge voltage of the sustain discharge pulse has a duty ratio of 50% or less.

5. The method of any one of claims 1 to 4 claim 1, wherein the reference voltage is 0V or more.

6. An aging method for a plasma display panel including a san electrode and a sustain electrode in a front panel and an address electrode in a rear panel,
wherein, after sustaining a sustain discharge pulse with a reference voltage of 0V or more, the sustain discharge pulse having a lower voltage than the reference voltage is alternatively applied to the scan electrode and the sustain electrode of the front panel, and the same as the reference voltage or a higher voltage than the reference voltage is applied to the address electrode of the rear panel to generate discharge.
